(19) United States
(12) Patent Application Publication
(10) Pub. No.: US 2019/0193736 A1
(43) Pub. Date: Jun. 27, 2019

(54) AUTOMATIC TRANSMISSION AND CONTROL METHOD OF THE SAME

(71) Applicant: JATCO Ltd, Fuji-shi, Shizuoka (JP)

(72) Inventor: Naohiro YAMADA, Shizuoka (JP)

(73) Assignee: JATCO Ltd, Fuji-shi, Shizuoka (JP)

(21) Appl. No.: 16/329,746

(22) PCT Filed: Jun. 16, 2017
(86) PCT No.: PCT/JP2017/022391

§ 371 Date: Feb. 28, 2019

(30) Foreign Application Priority Data
Sep. 14, 2016 (JP) 2016-179311

(51) Int. Cl. B60W 30/18; F16H 63/50; F16H 63/48; F16H 63/34; F16H 61/16; B60W 10/06; B60W 10/11; B60W 10/196

(52) U.S. Cl. CPC B60W 30/18118; F16H 63/50; F16H 63/48; F16H 63/3416; F16H 2059/663; B60W 10/06; B60W 10/11; B60W 10/196; B60W 30/18054; F16H 61/16

(57) ABSTRACT

An automatic transmission includes a park rod adapted to non-rotatably lock an output shaft of the automatic transmission, an actuator adapted to drive the park rod, and an ATCU adapted to drive the actuator when a setting range of the automatic transmission is set into a P range. In a situation where an accelerator pedal is pressed on a climbing slope, driving force and gradient resistance are balanced, and a vehicle is stopped, the ATCU does not set the setting range of the automatic transmission into the P range even when a shifter is operated into the P range.

### TECHNICAL FIELD

The present invention relates to an automatic transmission of a park by wire system.

### BACKGROUND ART

An automatic transmission of a park by wire system is an automatic transmission having no mechanical linkage between a shifter such as a shift lever and a shift switch and a parking mechanism adapted to non-rotatably lock an output shaft of the automatic transmission, in which an electric signal according to motion of the shifter is outputted to an actuator and the parking mechanism, etc. is actuated by the actuator (JP2008-128444A).

In such an automatic transmission, there is no need for mechanical linkage between the shifter and the parking mechanism. Thus, a layout property of the shifter is improved, and the parking mechanism can be actuated independently from operation of the shifter. Therefore, control freedom of the parking mechanism is improved.

### SUMMARY OF INVENTION

In the automatic transmission of the park by wire system, as described above, when a driver operates the shifter into a P range, a signal is outputted from a shift control unit to the actuator, the parking mechanism is actuated, and the output shaft of the automatic transmission is non-rotatably locked (park lock state).

There is a time lag after the shifter is operated into the P range and before park lock is completed. However, the driver normally operates the shifter into the P range in a state where a brake pedal is pressed. Thus, even when a vehicle is on a climbing slope, brake force acts on the vehicle and rolling back (rollback) of the vehicle is not problematic.

However, in a situation where the driver presses an accelerator pedal on a climbing slope, driving force and gradient resistance are balanced, and the vehicle is stopped, and in a case where the driver operates the shifter into the P range, due to the vehicle being stopped, the driver easily has the false impression that park lock is completed. When the driver cancels pressing of the accelerator pedal before completion of park lock, the vehicle rolls back due to self-weight.

Such rolling back may occur when disengagement of a power transmission clutch upon the shifter being operated into the P range is performed before the completion of park lock and the cancellation of the pressing of the accelerator pedal by the driver.

The present invention is achieved in consideration with such a technical problem, and an object thereof is to, in an automatic transmission of a park by wire system, prevent a vehicle from rolling back in a situation where a driver presses an accelerator pedal on a climbing slope, driving force and gradient resistance are balanced, and the vehicle is stopped, and even in a case where the driver operates a shifter into a P range.

According to an aspect of the present invention, an automatic transmission including a park lock mechanism adapted to non-rotatably lock an output shaft of the automatic transmission; an actuator adapted to drive the park lock mechanism; and a control unit adapted to drive the actuator when a setting range of the automatic transmission is set into a P range, is provided. In a situation where an accelerator pedal is pressed on a climbing slope, driving force and gradient resistance are balanced, and a vehicle is stopped, the control unit does not set the setting range of the automatic transmission into the P range even when a shifter is operated into the P range.

According to another aspect of the present invention, an automatic transmission including a park lock mechanism adapted to non-rotatably lock an output shaft of the automatic transmission; an actuator adapted to drive the park lock mechanism; and a control unit adapted to drive the actuator when a setting range of the automatic transmission is set into a P range, is provided. In a situation where an accelerator pedal is pressed on a climbing slope, driving force and gradient resistance are balanced, and a vehicle is stopped, and when a shifter is operated into the P range and the setting range of the automatic transmission is set into the P range, the control unit drives the actuator and gives brake force to the vehicle by an automatic brake mechanism.

According to yet another aspect of the present invention, an automatic transmission, including a park lock mechanism adapted to non-rotatably lock an output shaft of the automatic transmission; an actuator adapted to actuate the park lock mechanism; and a control unit adapted to drive the actuator when a setting range of the automatic transmission is set into a P range, is provided. In a situation where an accelerator pedal is pressed on a climbing slope, driving force and gradient resistance are balanced, and a vehicle is stopped, and when a shifter is operated into the P range and the setting range of the automatic transmission is set into the P range, the control unit drives the actuator, instructs an engine to maintain throttle opening, and maintains a power transmission clutch of the automatic transmission in an engaged state.

A control method of an automatic transmission corresponding to these is also provided.

According to these aspects, it is possible to prevent the vehicle from rolling back in a situation where the driver presses the accelerator pedal on a climbing slope, the driving force and the gradient resistance are balanced, and the vehicle is stopped, and even in a case where the driver operates the shifter into the P range.

### BRIEF DESCRIPTION OF DRAWINGS

FIG. 1 is a schematic configuration diagram of a vehicle including an automatic transmission according to an embodiment of the present invention.

FIG. 2 is a flowchart showing contents of park lock control.

FIG. 3 is a time chart for describing actions of the embodiment of the present invention.

FIG. 4 is a flowchart showing contents of another example of the park lock control.

FIG. 5 is a time chart for describing actions of the embodiment of the present invention.

FIG. 6 is a flowchart showing contents of further another example of the park lock control.

FIG. 7 is a time chart for describing actions of the embodiment of the present invention.

### DESCRIPTION OF EMBODIMENTS

Hereinafter, an embodiment of the present invention will be described with reference to the attached drawings.

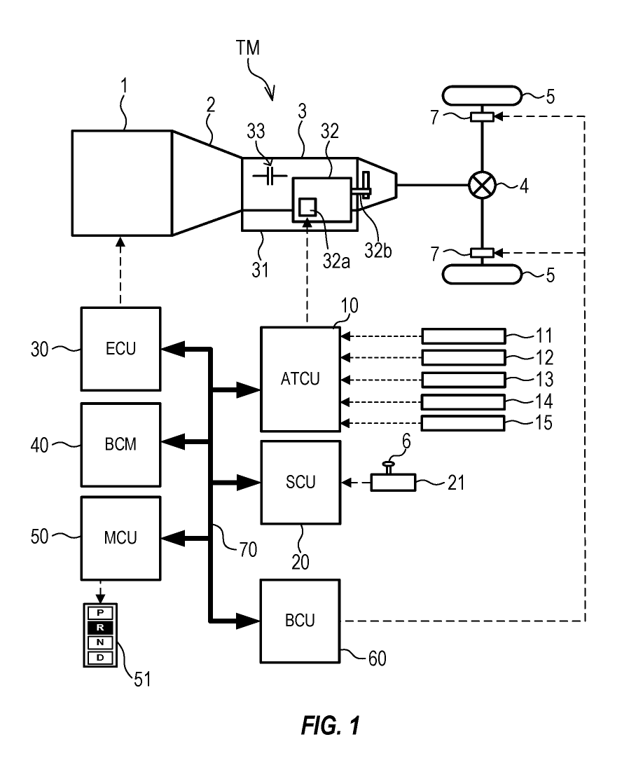

FIG. 1 is a schematic configuration diagram of a vehicle. The vehicle includes an engine 1 as a power source. Power of the engine 1 is transmitted to driving wheels 5 via an automatic transmission TM and a differential 4.

The automatic transmission TM is formed by a torque converter 2 and a transmission mechanism 3. The automatic transmission TM has a drive (D) range, a reverse (R) range, a neutral (N) range, a parking (P) range, etc., as ranges, and any one of the ranges can be set as a setting range. The D range and the R range serve as a running range, and the N range and the P range serve as a non-running range.

The setting range of the automatic transmission TM is set by a driver operating a shifter 6. The shifter 6 is, for example, a momentary type shift lever adapted to automatically return to a neutral position after the operation. However, the shifter may be a button type shift switch, etc. The range selected by the shifter 6 is detected by a shifter position sensor 21.

The transmission mechanism 3 is a stepped automatic transmission mechanism and has planetary gear mechanisms and plural friction engaging elements. In the transmission mechanism 3, by changing engaged states of the plural friction engaging elements, a gear ratio and forward/reverse movement can be switched. In the following description, a clutch and a brake to be engaged when the setting range of the automatic transmission TM is set in the running range will be collectively called as a power transmission clutch 33.

The transmission mechanism 3 further has a control valve portion 31 and a park module 32. The control valve portion 31 has plural solenoids adapted to control working hydraulic pressure of the plural friction engaging elements of the transmission mechanism 3.

The park module 32 mechanically locks an output shaft of the transmission mechanism 3 at the time of parking. In a case where the setting range of the automatic transmission TM is set into the P range, a park rod 32b is driven to a lock position by an actuator 32a. Thereby, an engagement claw (not shown) is engaged with a park gear (not shown) provided in the output shaft of the transmission mechanism 3, and the output shaft of the transmission mechanism 3 is mechanically locked (park lock state). Meanwhile, in a case where the setting range of the automatic transmission TM is set into the ranges other than the P range, the park rod 32b is driven to a lock cancellation position by the actuator 32a. Thereby, the engagement claw and the park gear (not shown) are disengaged, and lock of the output shaft of the transmission mechanism 3 is cancelled (park lock cancellation state).

A hydraulic brake device 7 is provided in each of the driving wheels 5 and driven wheels (not shown). Brake force acting on the vehicle from the brake devices 7 is adjusted in accordance with a pressing amount of a brake pedal by the driver, and in addition, the brake force can act on the vehicle at arbitrary timing upon receiving a signal from a BCU 60 to be described later.

An ATCU 10 is an automatic transmission control unit and performs control of the automatic transmission TM. Signals from an accelerator pedal opening sensor 11 adapted to detect accelerator pedal opening APO which is an operation amount of an accelerator pedal, a vehicle speed sensor 12 adapted to detect vehicle speed VSP, a parking position sensor 13 adapted to detect a position of the park rod 32b of the park module 32, a gradient sensor 14 adapted to detect gradient of a road surface at the position of the vehicle, a brake switch 15 adapted to detect whether or not the brake pedal is pressed, etc. are inputted to the ATCU 10.

The ATCU 10 is connected to a SCU 20, an ECU 30, a BCM 40, a MCU 50, and the BCU 60 via a CAN 70 so that the ATCU 10 and the units and the modules communicate with each other.

The SCU 20 is a shift control unit. On the basis of a signal from the shifter position sensor 21, the SCU 20 generates a demanded range signal corresponding to the range selected by the shifter 6 and outputs to the ATCU 10.

On the basis of the demanded range signal from the SCU 20, the ATCU 10 sets the setting range of the automatic transmission TM. In accordance with the setting range of the automatic transmission TM, the ATCU 10 outputs a control command value to the control valve portion 31 in a manner to be described next.

In a case where the range of the automatic transmission TM is set in the D range, the ATCU 10 refers to a shift map and determines a target gear position on the basis of the vehicle speed VSP and the accelerator pedal opening APO, and outputs a control command value for achieving the target gear position to the control valve portion 31. Thereby, the plural solenoids are controlled in accordance with the control command value, the working hydraulic pressure of the plural friction engaging elements is adjusted, and the target gear position is achieved.

In a case where the setting range of the automatic transmission TM is set into the R range, the ATCU 10 determines a reverse gear position as the target gear position, and outputs a control command value for achieving the target gear position to the control valve portion 31. In this case, the plural solenoids are controlled so that the reverse gear position is achieved.

In a case where the setting range of the automatic transmission TM is set into the P range or the N range, the ATCU 10 outputs a control command value for disengaging the power transmission clutch 33 to the control valve portion 31. In a case where the setting range is the P range, the ATCU 10 further actuates the actuator 32a of the park module 32, and brings the automatic transmission TM into the park lock state.

The ECU 30 is an engine control unit and controls the engine 1. The ECU 30 outputs rotation speed NE of the engine 1, throttle opening TVO, etc. to the ATCU 10.

The BCM 40 is a body control module and controls a vehicle body working element. The vehicle body working element is, for example, a door lock mechanism of the vehicle, etc. and includes a starter of the engine 1. The BCM 40 outputs ON/OFF signals of a door lock switch adapted to detect door lock of the vehicle, ON/OFF signals of an ignition switch of the engine 1, etc. to the ATCU 10.

The MCU 50 is a meter control unit and controls a meter, an alarming light, a display, a range indicator 51 adapted to display the setting range of the automatic transmission TM, etc. provided in the vehicle interior.

The BCU 60 is a brake control module and controls the brake force by the brake devices 7.

There is a time lag after the shifter 6 is operated into the P range and before park lock of the automatic transmission TM is completed. In a situation where the shifter 6 is operated into the P range, the driver normally presses the brake pedal. Thus, even on a climbing slope, the vehicle does not roll back due to this time lag.

However, in a situation where the driver presses the accelerator pedal on a climbing slope, driving force and gradient resistance are balanced, and the vehicle is stopped, there is a possibility that the vehicle moves back (rolls back). This is because, due to the vehicle being stopped, the driver has the false impression that park lock is completed before completion of park lock, and the driver cancels pressing of the accelerator pedal.

Thus, in the automatic transmission TM according to the present embodiment, by executing park lock control to be described below, rolling back of the vehicle is prevented.

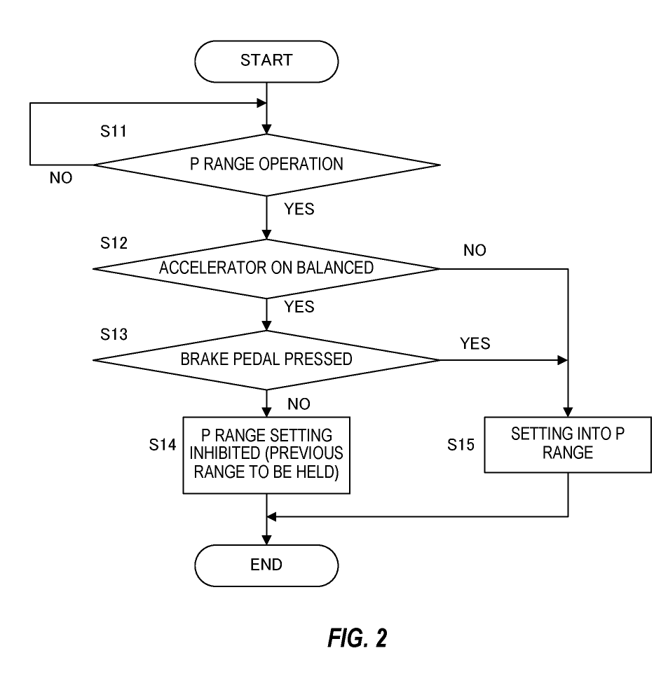

FIG. 2 shows contents of the park lock control to be executed by the ATCU 10.

This will be described. In Step S11, the ATCU 10 judges whether or not the shifter 6 is operated into the P range from the running range such as the D range and the R range on the basis of the signal from the shifter position sensor 21.

In a case where it is judged that the shifter 6 is operated into the P range from the running range, the ATCU 10 determines there is P range operation and lets the processing forward to Step S12. Judgement in Step S11 is repeatedly executed until it is judged that the shifter 6 is operated into the P range from the running range.

In Step S12, the ATCU 10 judges whether or not it is in an accelerator ON balanced state in which the vehicle is on a climbing slope, the accelerator pedal is pressed, and the driving force and the gradient resistance are balanced on the basis of the accelerator pedal opening APO, the vehicle speed VSP, and a detection value of the gradient sensor 14. Specifically, the ATCU 10 judges that it is in the accelerator ON balanced state in a case where the accelerator pedal opening APO is larger than zero, the vehicle speed VSP is zero, and the detection value of the gradient sensor 14 indicates a climbing slope.

The ATCU 10 lets the processing forward to Step S13 in a case of judging that it is in the accelerator ON balanced state, and lets the processing forward to Step S15 in a case of judging not.

In Step S13, the ATCU 10 judges whether or not the brake pedal is pressed on the basis of the signal from the brake switch 15.

The ATCU 10 lets the processing forward to Step S15 in a case of judging that the brake pedal is pressed, and lets the processing forward to Step S14 in a case of judging not.

In Step S14, the ATCU 10 holds the setting range of the automatic transmission TM to the previous range before the shifter 6 is operated into the P range (setting into the P range is inhibited). That is, the setting range of the automatic transmission TM is not set into the P range, the actuator 32a is not driven to the lock position, and the automatic transmission TM remains in the park lock cancellation state. Display of the range indicator 51 remains the previous range before the shifter 6 is operated into the P range.

Meanwhile, in Step S15, the ATCU 10 sets the setting range of the automatic transmission TM into the P range. Thereby, the actuator 32a is driven to the lock position, and the automatic transmission TM is brought into the park lock state. The ATCU 10 changes the display of the range indicator 51 to the P range.

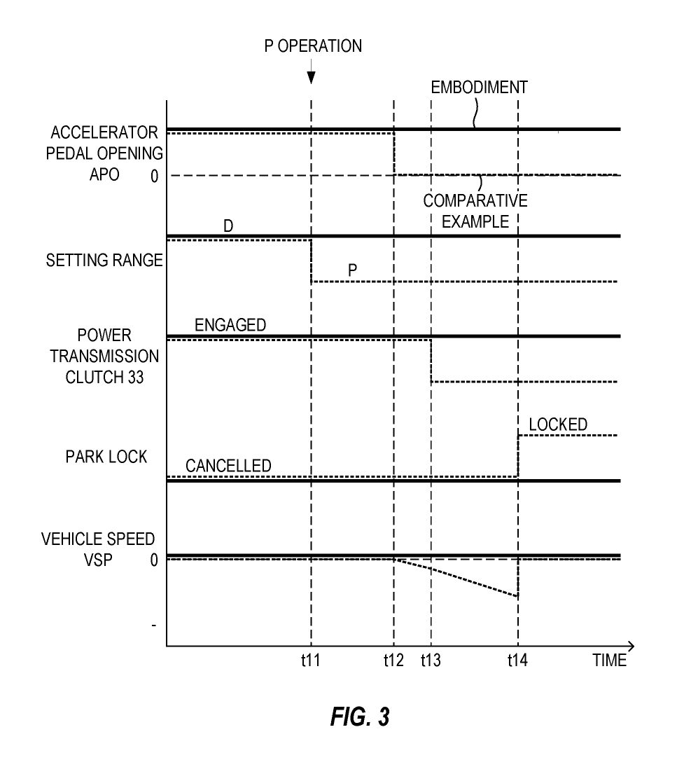

FIG. 3 is a time chart showing a state where the park lock control is performed in the accelerator ON balanced state on a climbing slope. Solid lines indicate the present embodiment, and broken lines indicate a comparative example in which the setting range of the automatic transmission TM is always set into the P range when the shifter 6 is operated into the P range.

When the shifter 6 is operated into the P range from the D range at time t11, the setting range of the automatic transmission TM is changed to the P range corresponding to the operation of the shifter 6 in the comparative example. There is a time lag after the setting range of the automatic transmission TM is changed to the P range and before the actuator 32a is driven to the lock position and park lock of the automatic transmission TM is completed. Thus, the automatic transmission TM is still in the park lock cancellation state at the point of the time t11.

However, in the accelerator ON balanced state, the vehicle is stopped, and further, the display of the range indicator 51 is changed to the P range upon receiving the change of the setting range of the automatic transmission TM to the P range. Thus, the driver easily has the false impression that the automatic transmission TM is brought into the park lock state and cancels the pressing of the accelerator pedal. In the comparative example, the pressing of the accelerator pedal is cancelled at time t12.

When the pressing of the accelerator pedal is cancelled in the accelerator ON balanced state, the driving force of the vehicle becomes only creeping force which is smaller than the gradient resistance. Thus, the vehicle starts rolling back due to self-weight (time t12 to t13).

Further, when the power transmission clutch 33 is disengaged at the time t13 upon receiving the change of the range of the automatic transmission TM to the P range, the driving force of the vehicle becomes zero and the rolling back of the vehicle becomes more obvious. The rolling back of the vehicle continues up to time t14 when park lock of the automatic transmission TM is completed.

In this example, after the pressing of the accelerator pedal is cancelled, the power transmission clutch 33 is disengaged. However, once the power transmission clutch 33 is disengaged, the driving force of the vehicle immediately becomes zero. Thus, even when the order is reverse, the rolling back of the vehicle similarly occurs.

Meanwhile, in the present embodiment, in a case where the vehicle is on a climbing slope in the accelerator ON balanced state, and even when the shifter 6 is operated into the P range, the setting range of the automatic transmission TM is not set into the P range (time t11).

When the setting range of the automatic transmission TM is not set into the P range, the display of the range indicator 51 does not become the P range, and the driver is able to recognize that park lock of the automatic transmission TM is not completed. Thereby, it is possible to prevent the rolling back of the vehicle due to cancellation of the pressing of the accelerator pedal when the driver has the false impression that park lock of the automatic transmission TM is completed.

A mode to let the driver recognize that the setting range of the automatic transmission TM is not set into the P range is not limited to the display of the range indicator 51 but may be other modes of providing an alarming sound, displaying an alarming message on a display, etc.

In a situation where there is no concern about the rolling back of the vehicle because the brake pedal is pressed, the setting range of the automatic transmission TM is set into the P range (Step S13 to Step S15 in FIG. 2). Thus, it is possible to reduce a situation where the operation of the shifter 6 does not match the setting range of the automatic transmission TM, and to suppress uncomfortable feeling the no-match gives the driver.

Next, another example of the park lock control will be described.

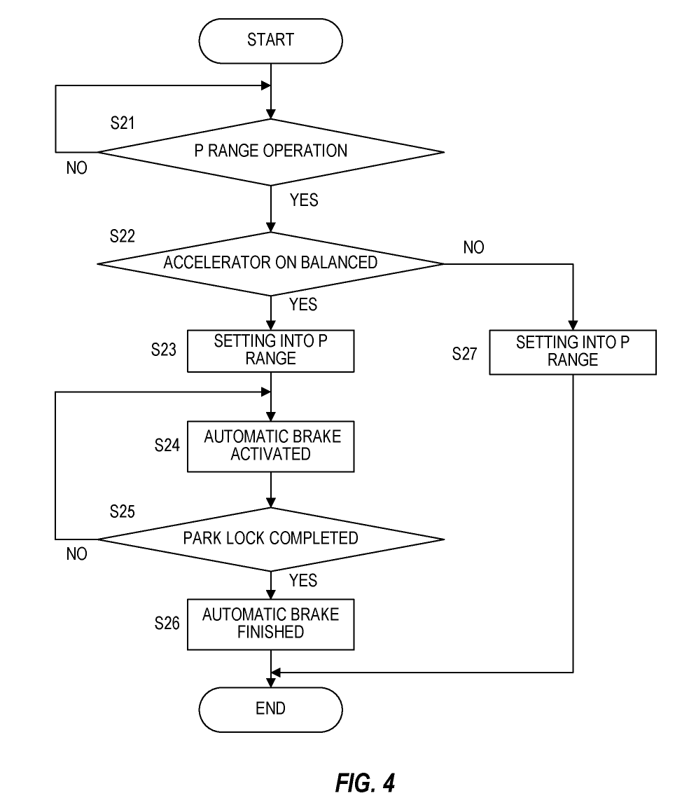

FIG. 4 shows contents of the above example of the park lock control to be executed by the ATCU 10.

This will be described. The processing of Steps S21 and S22 are the same as the processing of Steps S11 and S12 in FIG. 2. The ATCU 10 judges whether or not the shifter 6 is operated into the P range from the running range and whether or not it is in the accelerator ON balanced state, and lets the processing forward to Step S23 in a case of judging that the shifter 6 is operated into the P range from the running range and it is in the accelerator ON balanced state.

In Step S23, the ATCU 10 sets the setting range of the automatic transmission TM into the P range. Thereby, the actuator 32a is driven toward the lock position.

However, there is a time lag before the actuator 32a reaches the lock position and park lock of the automatic transmission TM is completed. Thus, in order to prevent the rolling back of the vehicle during this time lag, the ATCU 10 instructs the BCU 60 to activate the brake devices 7 in Step S24, and brake force acts on the vehicle by the brake devices 7 (automatic brake is activated).

On the basis of the signal from the parking position sensor 13, the ATCU 10 monitors in Step S25 whether or not the park rod 32b reaches the lock position, that is, whether or not park lock of the automatic transmission TM is completed.

When park lock of the automatic transmission TM is completed, the ATCU 10 lets the processing forward to Step S26, and instructs the BCU 60 to finish the automatic brake by the brake devices 7.

Meanwhile, in a case where it is judged that there is the P range operation not in the accelerator ON balanced state in Steps S21 and S22, the ATCU 10 lets the processing forward to Step S27, and performs only the processing of setting the setting range of the automatic transmission TM into the P range (normal processing).

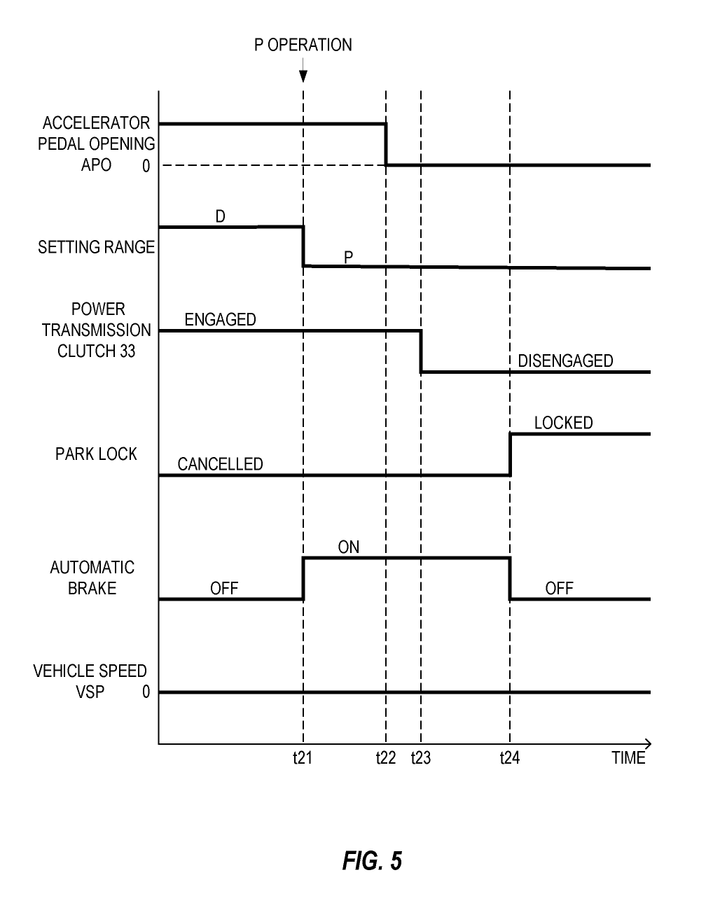

FIG. 5 is a time chart showing a state where the above example of the park lock control is performed in the accelerator ON balanced state on a climbing slope.

When the shifter 6 is operated into the P range from the D range at time t21, the setting range of the automatic transmission TM is set into the P range and the automatic brake by the brake devices 7 acts on the vehicle.

When the vehicle is stopped and the display of the range indicator 51 also becomes the P range, there is a possibility that the driver has the false impression that park lock of the automatic transmission TM is completed and cancels the pressing of the accelerator pedal. There is also a possibility that upon receiving the setting of the setting range of the automatic transmission TM into the P range, the power transmission clutch 33 is disengaged before the completion of park lock of the automatic transmission TM.

However, in this example, at the time t21 or later, the automatic brake by the brake devices 7 acts on the vehicle. Thus, even when the pressing of the accelerator pedal is canceled at time t22 and the power transmission clutch 33 is disengaged at time t23, the vehicle does not roll back.

The automatic brake by the brake devices 7 is cancelled after park lock of the automatic transmission TM is completed at time t24. Thus, it is possible to reliably prevent the rolling back of the vehicle.

In such a way, it is possible to effectively prevent the rolling back of the vehicle by the above example of the park lock control.

In this example, the automatic brake acts by the brake devices 7. However, another electrically-driven brake device may be provided separately from the brake devices 7 and the automatic brake may act by using this. Alternatively, the automatic brake may act by simultaneously engaging the friction engaging elements supposed to be not engaged simultaneously and non-rotatably locking the output shaft of the automatic transmission TM.

Next, further another example of the park lock control will be descried.

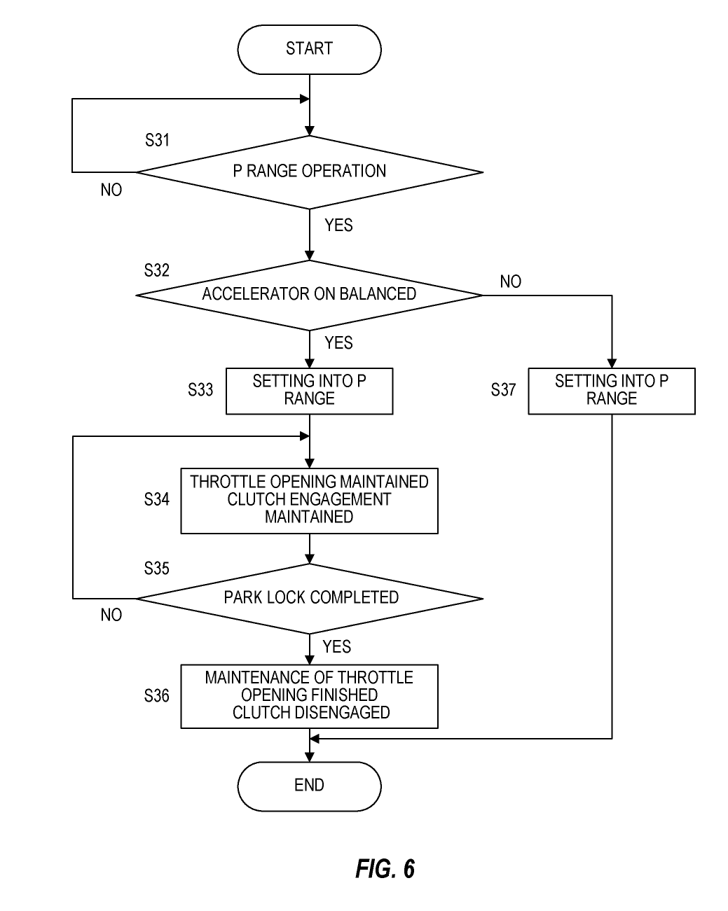

FIG. 6 shows contents of the above example of the park lock control to be executed by the ATCU 10.

This will be described. The processing of Steps S31 and S32 are the same as the processing of Steps S11 and S12 in FIG. 2. The ATCU 10 judges whether or not the shifter 6 is operated into the P range from the running range and whether or not it is in the accelerator ON balanced state, and lets the processing forward to Step S33 in a case of judging that the shifter 6 is operated into the P range from the running range and it is in the accelerator ON balanced state.

In Step S33, the ATCU 10 sets the setting range of the automatic transmission TM into the P range. Thereby, the actuator 32a is driven toward the lock position.

However, there is a time lag before the actuator 32a reaches the lock position and park lock of the automatic transmission TM is completed. Thus, in order to prevent the rolling back of the vehicle during this time lag, the ATCU 10 instructs the ECU 30 to maintain the throttle opening TVO of the engine 1 to the opening of the time, and maintains the power transmission clutch 33 in an engaged state in Step S34. Thereby, irrespective of accelerator pedal operation of the driver, the accelerator ON balanced state is continued.

On the basis of the signal from the parking position sensor 13, the ATCU 10 monitors in Step S35 whether or not the park rod 32b reaches the lock position, that is, whether or not park lock of the automatic transmission TM is completed.

When park lock of the automatic transmission TM is completed, the ATCU 10 lets the processing forward to Step S36, finishes the instruction to maintain the throttle opening TVO of the engine 1, and disengages the power transmission clutch 33.

Meanwhile, in a case where it is judged that there is the P range operation not in the accelerator ON balanced state in Steps S31 and S32, the ATCU 10 lets the processing forward to Step S37, and performs only the processing of setting the setting range of the automatic transmission TM into the P range (normal processing).

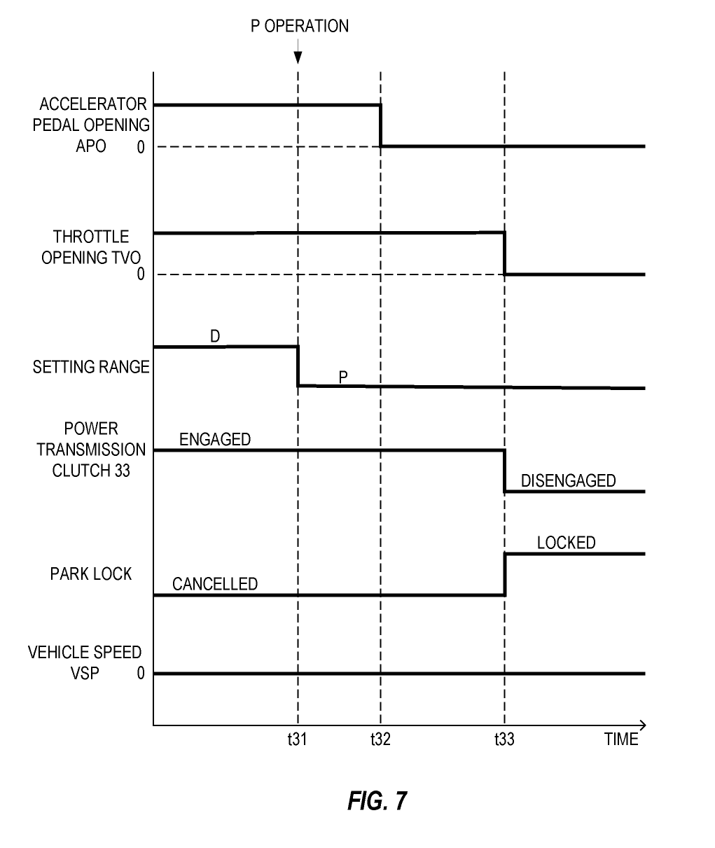

FIG. 7 is a time chart showing a state where the above example of the park lock control is performed in the accelerator ON balanced state on a climbing slope.

When the shifter 6 is operated into the P range from the D range at time t31, the setting range of the automatic transmission TM is set into the P range, the throttle opening TVO of the engine 1 is maintained to the opening of the time, and the power transmission clutch 33 is maintained in the engaged state irrespective of the setting range of the automatic transmission TM.

When the vehicle is stopped and the display of the range indicator 51 also becomes the P range, there is a possibility that the driver has the false impression that park lock of the automatic transmission TM is completed and cancels the pressing of the accelerator pedal. There is also a possibility that upon receiving the setting of the setting range of the automatic transmission TM into the P range, the power transmission clutch 33 is disengaged before the completion of park lock of the automatic transmission TM.

However, in this example, at the time t31 or later, the throttle opening TVO of the engine 1 is maintained to the opening of the time, and the power transmission clutch 33 remains engaged. Thus, even when the pressing of the accelerator pedal is canceled at time t32, it is possible to hold the accelerator ON balanced state in which the driving force of the vehicle and the gradient resistance are balanced. Therefore, the vehicle does not roll back.

The maintenance of the throttle opening TVO and the maintenance of the engagement of the power transmission clutch 33 are finished at time t33 after park lock of the automatic transmission TM is completed. Thus, it is possible to reliably prevent the rolling back of the vehicle.

In such a way, it is possible to effectively prevent the rolling back of the vehicle by the further above example of the park lock control.

The embodiment of the present invention is described above. However, the above embodiment does not intend to limit the technical scope of the present invention to the specific configuration of the above embodiment but only shows one of application examples of the present invention.

The present application claims a priority of Japanese Patent Application No. 2016-179311 filed with the Japan Patent Office on Sep. 14, 2016, all the contents of which are hereby incorporated by reference.

1-9. (canceled)

10. An automatic transmission, comprising:
a park lock mechanism adapted to non-rotatably lock an output shaft of the automatic transmission;
an actuator adapted to drive the park lock mechanism; and
a control unit adapted to drive the actuator when a setting range of the automatic transmission is set into a P range, wherein
in a situation where an accelerator pedal is pressed on a climbing slope, driving force and gradient resistance are balanced, and a vehicle is stopped, the control unit does not set the setting range of the automatic transmission into the P range even when a shifter is operated into the P range.

11. The automatic transmission according to claim 10, wherein
even in the situation, in a case where a brake pedal is pressed, the control unit sets the setting range of the automatic transmission into the P range when the shifter is operated into the P range.

12. An automatic transmission, comprising:
a park lock mechanism adapted to non-rotatably lock an output shaft of the automatic transmission;
an actuator adapted to actuate the park lock mechanism; and
a control unit adapted to drive the actuator when a setting range of the automatic transmission is set into a P range, wherein
in a situation where an accelerator pedal is pressed on a climbing slope, driving force and gradient resistance are balanced, and a vehicle is stopped, and when a shifter is operated into the P range and the setting range of the automatic transmission is set into the P range, the control unit drives the actuator, instructs an engine to maintain throttle opening, and maintains a power transmission clutch of the automatic transmission in an engaged state.

13. The automatic transmission according to claim 12, wherein
when lock of the output shaft of the automatic transmission by the park lock mechanism is completed, the control unit finishes instructing the engine to maintain the throttle opening, and disengages the power transmission clutch of the automatic transmission.

14. A control method of an automatic transmission including a park lock mechanism adapted to non-rotatably lock an output shaft of the automatic transmission, and an actuator adapted to drive the park lock mechanism, the control method comprising:
in a situation where an accelerator pedal is pressed on a climbing slope, driving force and gradient resistance are balanced, and a vehicle is stopped, not setting a setting range of the automatic transmission into a P range even when a shifter is operated into the P range.

15. A control method of an automatic transmission including a park lock mechanism adapted to non-rotatably lock an output shaft of the automatic transmission, and an actuator adapted to actuate the park lock mechanism, the control method comprising:
in a situation where an accelerator pedal is pressed on a climbing slope, driving force and gradient resistance are balanced, and a vehicle is stopped, and when a shifter is operated into a P range and a setting range of the automatic transmission is set into the P range, driving the actuator, instructing an engine to maintain throttle opening, and maintaining a power transmission clutch of the automatic transmission in an engaged state.
